(19) United States
(12) Patent Application Publication
(10) Pub. No.: US 2014/0231487 A1
(43) Pub. Date: Aug. 21, 2014

(54) STAPLER

(71) Applicant: PLUS CORPORATION, Tokyo (JP)

(72) Inventor: Shinya ABE, Tokyo (JP)

(73) Assignee: PLUS CORPORATION, Tokyo (JP)

(21) Appl. No.: 13/975,506

(22) Filed: Aug. 26, 2013

(30) Foreign Application Priority Data
Feb. 18, 2013 (JP) 2013-028867

(51) Int. Cl. B25C 5/02

(52) U.S. Cl. CPC B25C 5/0207; B25C 5/0221
USPC 227/129; 227/120

(57) ABSTRACT

To provide a stapler for fastening even a large number of sheets of paper whether used as a desktop or hand-held stapler, there is provided a stapler having above a base portion a clincher portion where sheets of paper are placed and a housing portion including a magazine portion accommodating staples and a driving blade driving out the staples, including within the base portion a desk resting lever actuated when the base portion is placed on a desk, a plate which slides when the desk resting lever is actuated and a slider receiver, wherein with the base portion placed on the desk, the desk resting lever is actuated, causing the plate to slide to thereby cause the slider receiver integral with the plate to move slightly, so that the movement towards the base portion of the clincher portion operating in association with rotation of the handle portion is delayed.

### CROSS-REFERENCE TO RELATED APPLICATION

This application is based upon and claims the benefit of priority under 35 USC 119 to Japanese Patent Application No. 2013-028867 filed on Feb. 18, 2013, the entire contents of which are incorporated herein by reference.

### FIELD

The present invention relates to a flat-type stapler which drives out a staple in such a way that end portions of the staple are bent flat after they pass through sheets of paper to be fastened together.

### BACKGROUND

Staplers are used as a piece of stationery for fastening sheets of paper together and are indispensable office supplies. In some of these staplers, a staple is driven out in such a way that right-angled end pieces thereof penetrate sheets of paper and are then bent into a curved fashion to fasten them together. In other flat-type staplers, right-angled end pieces of a staple are bent flat after they pass through sheets of paper to be fastened together. In recent years, the flat-type staplers are getting so popular as to constitute a main stream of staplers marketed since sheets of paper that are fastened together are not bulky. Thus, a number of flat-type staplers have been proposed now.

There is prepared a line-up of small-sized, medium-sized and large-sized staplers, which use small, medium and large staples, respectively, according to their size. Then, users properly use these staplers which are different in size according to types and volumes of sheets of paper to be fastened.

In these staplers, the small-sized stapler is a palm-sized, light stapler which is easy to be carried and is used mainly in a state of holding it in the hand to fasten about 20 sheets of paper together. The large-sized stapler is intended to be used on a table or desk and is constructed so robustly as to bear the weight of a user, who attempts to apply his or her weight to the stapler placed on the table or desk so as to press down a handle member of the stapler to fasten a maximum of about 60 sheets of paper at one time.

In addition, the middle-sized stapler is an all-purpose stapler. This middle-sized stapler can be used while being gripped in a hand of a user or placed on a table or desk and can fasten a maximum of about 30 sheets of paper together at one time.

KOKAI (Japanese Unexamined Patent Publication) No. 2011-131353 discloses a stapler which includes a sheet table on which sheets of paper to be fastened are placed, a magazine that is disposed to face oppositely the sheet table and which holds fastening staples, a driving blade which drives the fastening staples held in the magazine in the direction of the sheet table one by one, an anvil which bends penetrating end portions of the fastening staple driven out by the driving blade which penetrate through the sheets of paper by a bending abutment surface or a forming abutment surface and an abutment surface selection mechanism which brings the fastening staple into engagement with the bending abutment surface and thereafter brings it further into engagement with the forming abutment surface at the time of the penetrating end portions being bent by the anvil. This stapler is disclosed in KOKAI as a flat-type stapler in which a fastening staple can be bent flat to fasten the sheets of paper without incurring the buckling of the fastening staple.

The stapler disclosed in KOKAI (Japanese Unexamined Patent Publication) No. 2011-131353 has the abutment surface selection mechanism which causes the bending abutment surface and the forming abutment surface to be switched over during the series of pressing operations of the fastening staple thereagainst. However, in a flat-type stapler like this of a medium size, there will be no problem when it is placed on a desk at a base portion thereof to fasten a large number of sheets of paper with a strong force applied thereto. However, the robust construction of this medium-sized, flat-type stapler has caused inconvenience when it is held with both hands of a user to fasten a relatively small number of sheets of paper together.

In addition, in the medium-sized, flat-type stapler, when it is held with the hands for use or is placed on the table for use, it has occurred from time to time that a staple cannot penetrate through sheets of paper to be fastened together properly, resulting in a drawback that the sheets of paper cannot be fastened together well.

### SUMMARY

The invention has been made in view of the problems inherent in the related art described above, and an object thereof is to provide a stapler which can be used both as a desktop stapler which can fasten even a large number of sheets of paper in a stable fashion and a hand-held-type stapler.

According to an aspect of the invention, there is provided a stapler having above a base portion a clincher portion on which sheets of paper to be fastened together with a staple are placed and a housing portion including a magazine portion which accommodates the staple and a driving blade which drives out the staple, including: a desk resting lever which is actuated when the base portion is placed on a desk or the like; a plate which slides when the desk resting lever is actuated; and a slider receiver that locks the movement of the clincher portion, on which the sheets of paper to be fastened together with the staple are placed, towards the base portion and which moves in association with sliding of the plate, the desk resting lever, the plate and the slider receiver being disposed within the base portion, wherein when the base portion is placed on the desk or the like, the desk resting lever is actuated to thereby cause the plate to slide to thereby cause the slider receiver which is in engagement with the plate to move slightly, so that the movement towards the base portion of the clincher portion which operates in association with rotating operation of the handle portion is delayed.

Preferably, the desk resting lever is disposed so that a distal end thereof projects from a lower surface of the base portion.

When the distal end of the desk resting lever is situated substantially in the same plane as the lower surface of the base portion, the slider receiver preferably retreats slightly.

The stapler preferably includes an engagement projection which is brought into abutment with a rotational arm in the housing portion which is actuated by rotation of the handle portion.

According to an aspect of the invention, it is possible to provide the stapler which can fasten even a large number of sheets of paper together in a stable fashion whether it is used as a desktop or tabletop stapler or a hand-held stapler. Namely, in the stapler of the invention, when placing the stapler on a desk or table for use, even when the handle portion is operated by means of a strong force applied to the stapler placed on the desk or table for use so that the handle portion is lowered quickly, the clinching operation is executed after the staple has penetrated through the sheets of paper in an ensured fashion by delaying the movement of the clincher portion towards the base portion by the desk resting lever, whereby the legs of the staple can be bent to fasten the sheets of paper in an ensured fashion, thereby making it possible to prevent the buckling of the staple.

In addition, when with the stapler is placed on the desk or table and the handle portion is pressed downwards, the distal end of the desk resting lever is allowed to retreat to the lower surface of the base portion by causing the distal end of the desk resting lever to project from the lower surface of the base portion.

Further, the amount by which the slider receiver and the slider projection are superposed one on top of the other is increased by causing the slider receiver to retreat when the distal end of the desk resting lever retreats to the lower surface of the base portion, whereby the start of lowering of the clincher portion can easily be delayed.

Furthermore, in the stapler of the invention, the clincher portion moves towards the base portion in association with rotation of the handle portion, whereby whether or the number of sheets of paper to be fastened together is large or small, the sheets of paper can be fastened together in an ensured fashion.

### BRIEF DESCRIPTION OF THE DRAWINGS

FIG. 1 is a front perspective view showing an external view of a stapler according to an embodiment of the invention.

FIG. 2 is a front perspective view showing a state in which a magazine of the stapler according to the embodiment of the invention is drawn out.

FIG. 3 is a sectional view of the stapler according to the embodiment of the invention.

FIG. 4 is a sectional view showing an operating state of the stapler according to the embodiment of the invention in which sheets of paper are held therein.

FIG. 5 is a sectional view showing an operating state of the stapler according to the embodiment of the invention in which a staple is inserted through the sheets of paper.

FIG. 6 is a sectional view showing an operating state of the stapler according to the embodiment of the invention in which the sheets of paper are fastened together.

FIGS. 7A and 7B show sectional views showing an operation of a desk resting lever of the stapler according to the embodiment of the invention.

FIGS. 8A and 8B show sectional views showing an operation of a slider receiver of the stapler according to the embodiment of the invention.

### DETAILED DESCRIPTION

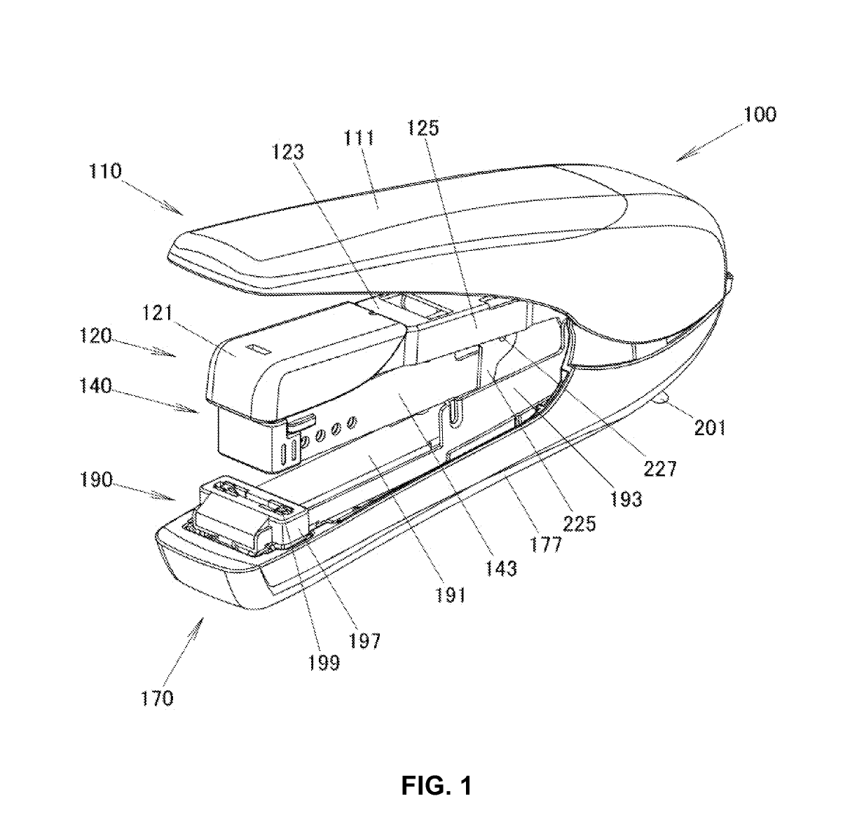

Hereinafter, an embodiment of the invention will be described in detail based on the drawings. When describing a stapler 100 of the invention, as shown in FIG. 1, a side where a handle portion 110 is provided is regarded as an upper side, a side where a base portion 170 is provided as a lower side, an end where the handle portion 110 and the base portion 170 are connected together as a rear end, and an end where the handle portion 110 and the base portion 170 are left separated to define an opening therebetween as a front end of the stapler 100.

As shown in FIG. 1, the stapler 100 of the invention has a housing portion 120 between the handle portion 110 and the base portion 170, and the housing portion 120 includes a magazine portion 140 which holds staples and a driving blade 131 which drives out the staples in the magazine one by one. The stapler 100 has a clincher portion 190 in the base portion 170 which is adapted to move vertically therein, and a movable clincher 199 is provided in the clincher portion 190.

Thus, the stapler 100 is made into a medium-sized, flat-type stapler 100 which can bend legs of a stapler flat by the clincher portion 190. Namely, this stapler 100 is an all-purpose stapler 100 which can be used both as a hand-held stapler which is held with one or both hands of a user for use and a tabletop stapler which is placed on a table for use so that a handle portion is pressed by the palm of the hand of the user.

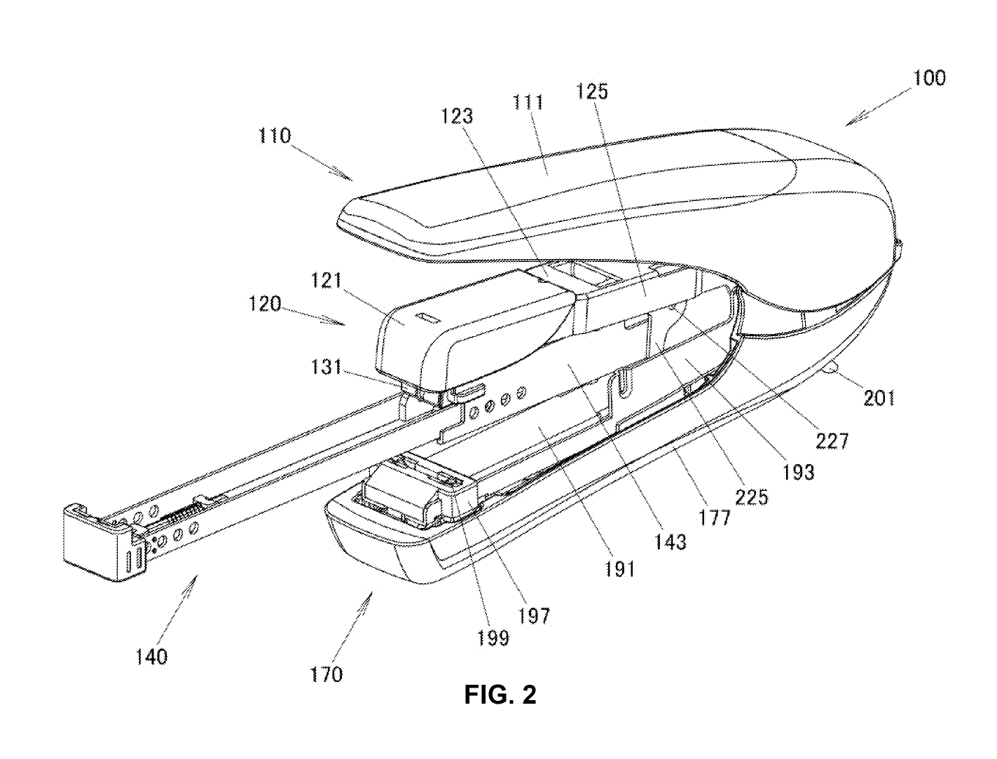

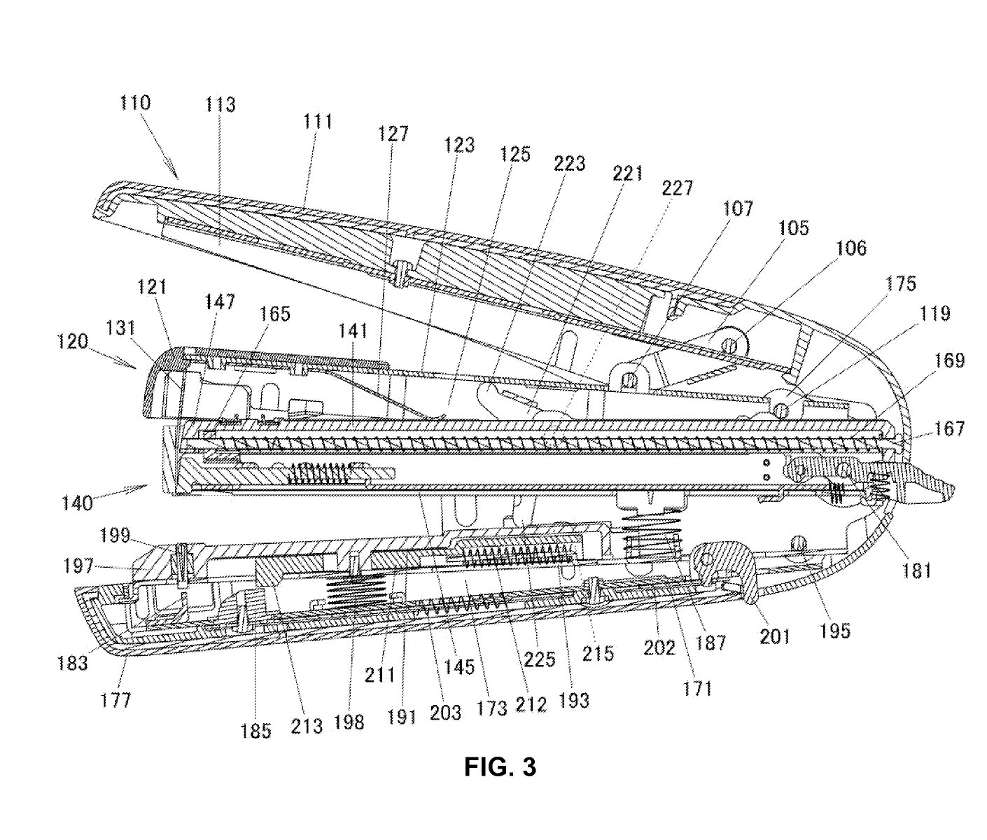

As shown in FIGS. 2 and 3, the stapler 100 has a handle arm 113 in the handle portion 110. This handle arm 13 has a required longitudinal length and a cross section having an inverted U-shape which is opened on a lower side to ensure its rigidity. Additionally, in the handle portion 110 of the stapler 100, a handle cover 111, which has an appropriately curved surface, is placed on the handle arm 113 so as to facilitate the gripping of the stapler 100.

In addition, the base portion 170, which is connected to the handle portion 110 at the rear of the stapler 100, has a base plate. This base plate includes a base bottom plate 171 which is a thin metallic flat plate having a required longitudinal length, base side plates 173 which rise along both sides of the base bottom plate 171 and raised walls 175 which are highly raised in height near rear end portions of the base side plates 173. The base portion 170 additionally has a plate 202 which is situated underneath the base bottom plate 171 and is adapted to slidably move as will be described later, as well as a base cover 177 which covers this plate 202 and the base side plates 173.

In addition, in this stapler 100, the handle portion 110 is fixed rotatably to the base portion 170 by a handle shaft 119 which is provided near upper ends of the raised walls 175. Additionally, the housing portion 120 and the magazine portion 140 are attached rotatably to the base portion 170 by a rotating shaft 181 which is provided in a medium height position near rear ends of the raised walls 175.

The housing portion 120 has a housing top plate 123 and housing side plates 125. The housing top plate 123 is a flat plate and is slightly shorter in length than the handle arm 113. The housing side plates 125 extend downwards along both sides of the housing top plate 123. The housing portion 120 also has the driving blade 131 inside the housing top plate 123 near a front end thereof. The housing portion 120 further includes a housing cover 121 which covers a front end portion of the housing portion 120.

A position on the housing top plate 123 which is situated slightly further rearwards than a central portion thereof and a position on the handle arm 113 which is situated near a rear end thereof and further forwards than the handle shaft 119 are connected by a link bar 105. This link bar 105 is fixed rotatably to the handle arm 113 by an upper link shaft 106 at one end thereof and is fixed rotatably to the housing top plate 123 by a lower link shaft 107 at the other end thereof.

The housing portion 120 has the driving blade 131 which drives out a staple in the vicinity of a front end thereof and incorporates therein an elastic member 127 which defines a predetermined space between the front end of the housing portion 120 and a front end of the magazine portion 140.

Although the driving blade 131 and the elastic member 127 are formed into an integral unit by a steel plate as shown in FIG. 3, the elastic member 127 can be made by using a separate elastic member which is formed of an appropriate different material from that of the driving blade 131.

Additionally, as shown in FIG. 2, in the magazine portion 140, a magazine case main body portion can be drawn to the front from a magazine case.

The magazine case has a magazine case upper plate 141, magazine case side plates 143 which extend downwards from the magazine case upper plate 141 along both sides of the magazine case upper plate 141 and magazine case lower plates 145 which project transversely inwards from respective lower ends of the left and right magazine side pates 143 and holds the magazine case main body portion so as to slide longitudinally.

The magazine case has a magazine case front plate 147 at a front end thereof which extends slightly downwards from the magazine case upper plate 141. A space is formed below the magazine case front plate 147 so as to allow for the passage of staples accommodated in the magazine case main body portion, and the a staple holder 165 is prevented from projecting to the front from the magazine case by the magazine case front plate 147. Additionally, the magazine case front plate 147 facilitates the insertion of a strip of staples into the magazine case main body portion, when the magazine case main body portion is pulled out.

In addition, the magazine portion 140 includes an elastic member 187 such as a coil spring between the magazine case lower plates 145 and a clincher base frame 193. Thus, a gap is defined between the front end of the magazine portion 140 and the front end of the base portion 170 by this elastic member 187 so that sheets of paper can be held in the gap so defined.

In attaching the movable clincher 199 to the base portion 170, a portion lying near a rear end of the clincher base frame 193 is fixed rotatably to a lower position in the raised walls 175, which is positioned at the rear of the base side plates 173, by a clincher pin 195, so that the clincher base frame 193 can be moved vertically at a front end thereof.

A clincher cover 197 which incorporates therein the movable clincher 199 is provided at a front end of a clincher base plate 191 which is provided on the clincher base frame 193. The clincher base plate 191 and the clincher base frame 193 are pushed up by an elastic member 198, and the front end of the clincher base frame 193 is brought into engagement with an inside of the front end of the base portion 170, whereby the clincher cover 197 is positioned in a predetermined height position.

Further, a slider plate 211 is attached to a lower surface of the clincher base plate 191 so as to slide back and forth. A slider projection 213 which projects downwards is provided at a front end of the slider plate 211, and upwardly projecting engagement projections 215 are provided on left- and right-hand sides of a rear end of the slider plate 211. Then, the slider plate 211 is biased to the front by an elastic member 212.

In addition, a slider receiver 185 is provided below the slider projection 213, and this slider receiver 185 is integrated with the plate 202 which is situated between the base bottom plate 171 and the base cover 177 so as to slidably move together with the plate 202. A front end of the slider plate 211, that is, a front end of the clincher base plate 191 including the movable clincher 199 is prevented from being lowered by a rear end of the slider receiver 185 being superposed on a front end of the slider projection 213.

A clincher locking portion 183 is disposed below the movable clincher 199. The clincher locking portion 183 is provided on the base bottom plate 171 and is intended to support a bottom of the movable clincher 199 by being inserted into the clincher cover 197 when the front end of the clincher portion 190 is lowered. In addition, the elastic member 198 such as a coil spring is disposed between the base bottom plate 171 and the clincher base plate 191 so as to push up the clincher portion 190.

Further, two rotational arms 221 having the same shape are respectively attached rotatably to each sides of both the magazine case side plates 143 and forwards and upwards of the engagement projections 215 by corresponding arm shafts 227 whose axial positions are aligned with each other. Each rotational arm 221 has a first arm 223 and a second arm 225. The first arms 223, which extend forwards and upwards from the arm shafts 227, are disposed inside the housing side plates 125 so that distal ends thereof are brought into contact with a lower surface of the housing top plate 123. The second arms 225, which extend downwards from the arm shafts 227, are disposed so that distal ends thereof are positioned forwards and upwards of the respective engagement projections 215 of the slider plate 211 which is attached to the base portion 170.

These rotational arms 221 are attached to the magazine case by the arm shafts 227, and therefore, when the magazine portion 140 is lowered so that a drive-out opening is caused to approach the movable clincher 199, the distal ends of the second arms 225 are lowered to a position lying in front of the engagement projections 215. Then, when the housing portion 120 approaches the magazine portion 140 so that a staple is driven out of the drive-out opening by the driving blade 131, the distal ends of the first arms 223 are pressed downwards by the housing top plate 123, whereby the rotational arms 221 rotate about the arm shafts 227. This moves the distal ends of the second arms 225 towards the rear to thereby move the engagement projections 215 towards the rear, which triggers a rearward movement of the slider plate 211 and the slider projection 213.

Next, the operation of the stapler 100 according to the embodiment will be described. As shown in FIG. 3, when no force is applied to the handle portion 110, the clincher portion 190 is biased upwards by means of the force of the elastic member 198. As this occurs, the slider plate 211 is biased to the front by the elastic member 212, and therefore, the slider projection 213, which is integrated with the slider plate 211, is position forwards, and the slider projection 213 and the slider receiver 185 are locked together while being superposed one on the top of the other, whereby the front end of the slider plate 211, that is, the front end of the clincher base plate 191 including the movable clincher 199 are prevented from being lowered.

In addition, the magazine portion 140 is biased upwards by means of the force of the elastic member 187 which is disposed between the magazine portion 140 and the base portion 170. Additionally, the handle portion 110 is connected to the housing portion 120 by the link bar 105, and the magazine portion 140 which is positioned below the housing portion 120 is kept spaced apart from the housing portion 120 by the elastic member 127.

Because of this, the front end of the base portion 170 and the front end of the magazine portion 140 are kept apart from each other to define an opening therebetween. The front end of the magazine portion 140 and the front end of the housing portion are kept spaced apart from each other, and the front end of the housing portion 120 and the front end of the handle portion 110 are also kept spaced apart from each other.

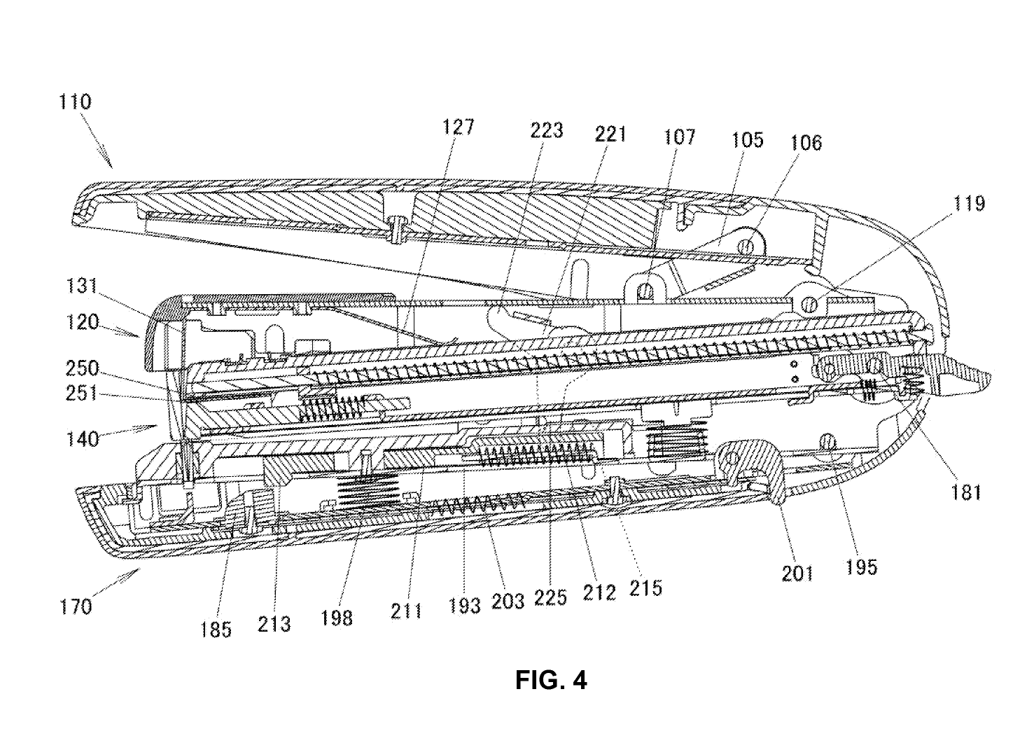

Then, when the front end of the handle portion 110 is lowered, the handle portion 110 rotates downwards about the handle shaft 119 as shown in FIG. 4. When the front end of the handle portion 110 continues to be lowered further, the link bar 105 is caused to operate so as to rotate the housing portion 120 downwards.

When the front end of the handle portion 110 continues to be lowered furthermore, as the housing portion 120 is lowered, the magazine portion 140 rotates downwards integrally together with the housing portion 120 so as to maintain the gap between the housing portion 120 and itself. Thus, the magazine portion 140 is actuated in a direction in which sheets of paper, not shown, which are disposed between the magazine portion 140 and the clincher portion 190 are held therebetween.

Then, when the front end of the handle portion 110 continues to be lowered further, the front end of the magazine portion 140 is lowered as downwards as a position where the front end of the magazine portion 140 comes into contact with the sheets of paper, not shown, which are superposed one on the top of the other as shown in FIG. 4, whereby the sheets of paper are held by the magazine portion 140 and the clincher cover 197 therebetween.

Here, the clincher cover 197, which is part of the clincher portion 190, is locked by the slider projection 213 which is integrated with the slider plate 211 and the slider receiver 185 provided in an interior of the base portion 170 so as to be kept in a block state while being prevented from being lowered.

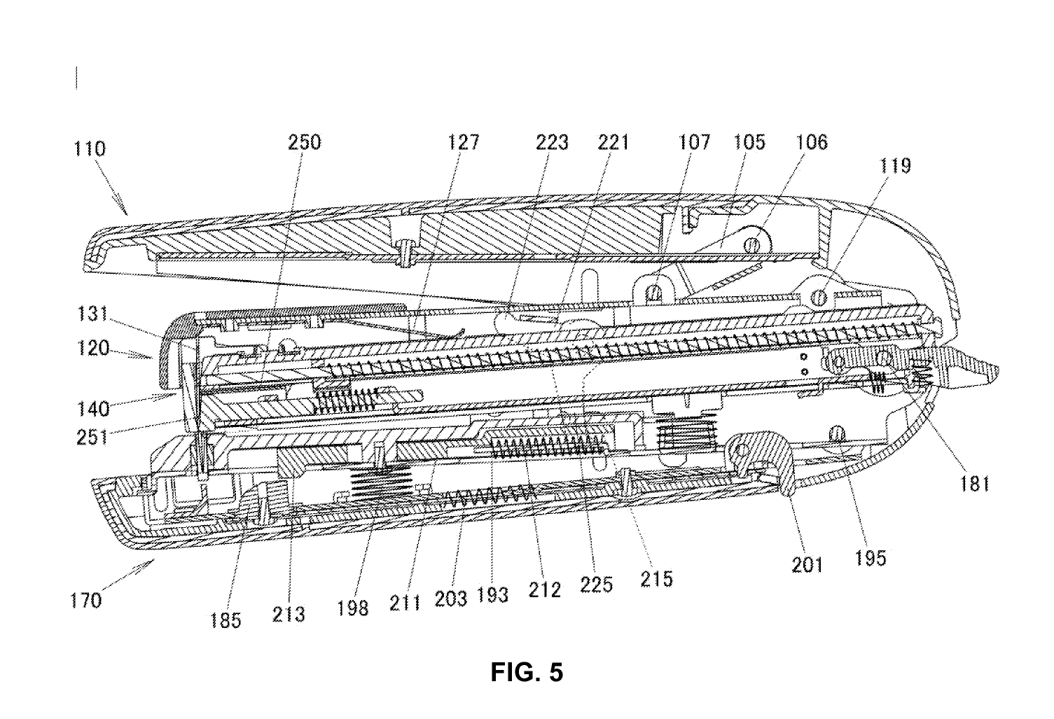

When the front end of the handle portion 110 is lowered further in this state, as shown in FIG. 5, the front end of the housing portion 120 is lowered, so that a staple 251 of a strip of connected staples 250 which is positioned at a distal end thereof is pushed to be driven downwards by the driving blade 131.

Then, when the front end of the handle portion 110 continues to be lowered, as the housing portion 120 rotates, legs of the staple 251 which is pushed to be driven downwards by the driving blade 131 penetrate through the sheets of paper, while the second arms 225 are actuated to move to the rear by the rotation of the rotational arms 221 attached to the magazine portion 140 which is triggered as the housing portion 120 rotates a predetermined amount to thereby be brought into engagement with the engagement projections 215 of the slider plate 211.

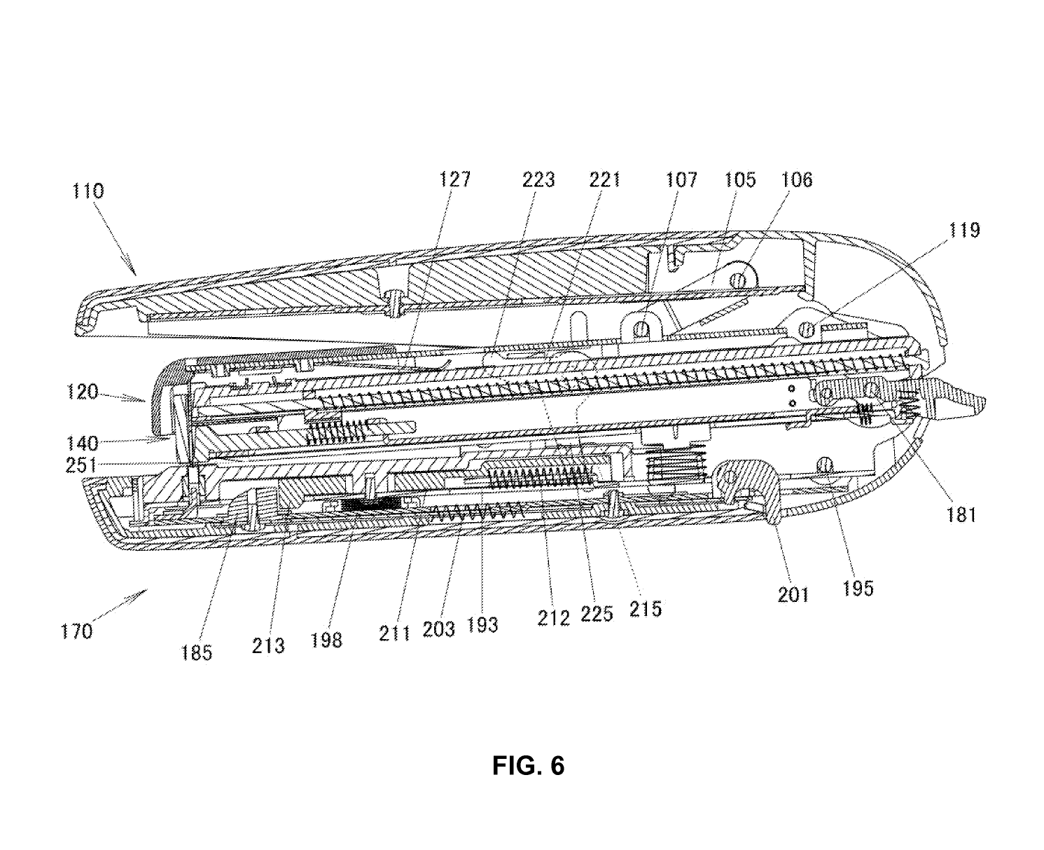

When the front end of the handle portion 110 continues to be lowered further after the second arms 225 are brought into abutment with the engagement projections 215 as a result of the operation of the rotational arms 221, the second arms 225 cause the engagement projections 215 to retreat as shown in FIG. 6, whereby the slider plate 211 which is integrated with the engagement projections 215 is caused to slide to the rear.

Then, when the slider plate 211 slides to the rear, the slider projection 213 which is integrated with the slider plate 211 at the front of the slider plate 211 moves to the rear, which releases the locking of the slider projection 213 which have been locked by the slider receiver 185, whereby the clincher cover 197 of the clincher portion 190 is lowered into the base portion 170 as the housing portion 120 is lowered.

It should be noted that the slider receiver 185 of the invention is integrated with the plate 202, which will be described later, and when the stapler 100 is used on a table or desk, the plate 202, which will be described later, is moved slightly to the rear by a desk resting lever 201 which is actuated when the base portion 170 is placed on the desk. The desk resting lever 201, the plate 202 and the like will be described in detail later.

Then, the staple 251, which has penetrated through the sheets of paper as a result of the driving blade 131 of the housing portion 120 having been lowered in association with the front end of the handle portion 110 being lowered, is lowered in the base portion 170 together with the clincher cover 197 of the clincher portion 190, whereby the clincher locking portion 183 is brought into abutment with the movable clincher 199 from therebelow as the clincher portion 190 is lowered.

By the abutment of the clincher locking portion 183 with the movable clincher 199, the legs of the staple 251 are held by the movable clincher 199 which is supported on the lower side thereof by the clincher locking portion 183 and the driving blade 131 therebetween to thereby bent flat to fasten the sheets of paper together.

Then, when the application of the force to the handle portion 110 is stopped to release the handle portion 110, the stapler 100 is restored to its initial state shown in FIG. 1 or 3 by the elastic forces of the elastic members, where the opening is defined between the handle portion 110 and the base portion 170.

Next, a configuration of the stapler 100 will be described in detail by reference to the drawings in which the movement of the clincher portion 190, which operates in association with the rotating operation of the handle portion 110, is delayed by causing the slider receiver 185 to move slightly by the operation of the desk resting lever 201.

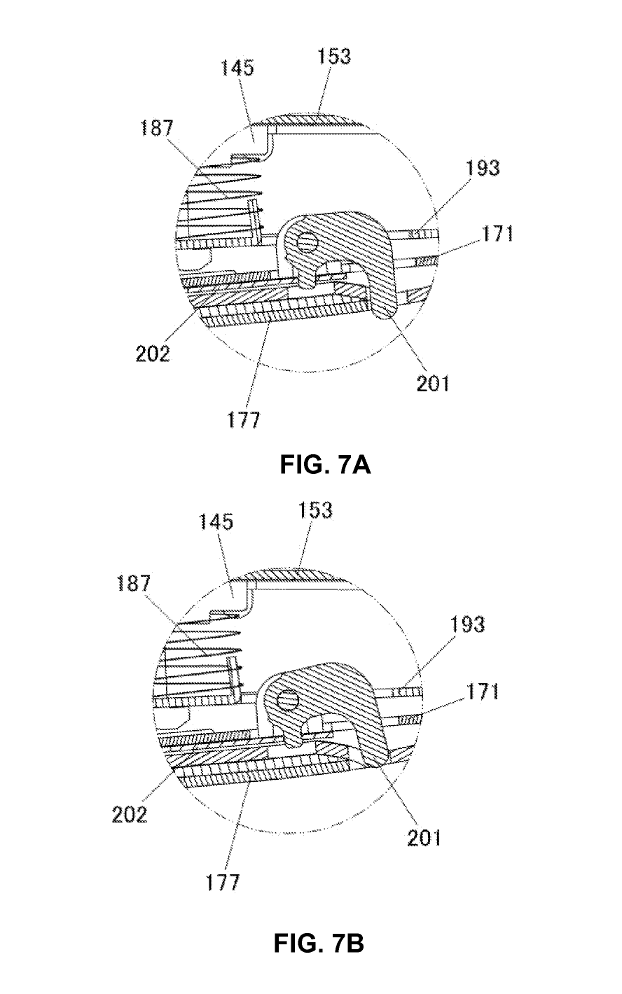

As shown in FIG. 7A and 7B, the stapler 100 includes, in the interior of the base portion 170, the desk resting lever 201 which operates when the base portion 170 is placed on a desk or the like, the plate 202 which is actuated to slide as the desk resting lever 201 operates and the slider receiver 185 which locks the downward movement of the clincher portion 190, on which sheets of paper to be fastened together with a staple 251 are placed, towards the base portion 170. This slider receiver 185 is in integral engagement with the plate 201 so as to move together with the plate 202.

The desk resting lever 201 is positioned at the rear of and below the base portion 170 as shown in FIG. 1 and is a mechanism component having a U-shape and formed of a hard resin as shown in FIG. 7A. The desk resting lever 201 is disposed so that a rear end of the U-shape, which is one end thereof, projects outwards from a lower surface of the base portion 170.

Additionally, the desk resting lever 201 is in engagement with the plate 202 at the other end which is a front end of the U-shape thereof. Then, by causing the one end of the desk resting lever 201 to project from the lower surface of the base portion 170 of the stapler 100, when the stapler 100 is placed on a desk or the like, the desk resting lever 201 operates as shown in FIG. 7B so that the one end or rear end of the desk resting lever 201 is moved into the interior of the base portion 170 at the rear thereof from the projecting state to such an extent that the rear end is positioned substantially on the same plane as the lower surface of the base portion 170. Thus, the desk resting lever 201 rotates slightly.

When the one end of the desk resting lever 201 operates to enter the interior of the base portion 170 at the rear thereof in this way, the other end of the desk resting lever 201 operates so as to rotate a slight angle towards the rear, whereby the plate 202 which is in engagement with the desk resting lever 201 is caused to slide slightly to the rear.

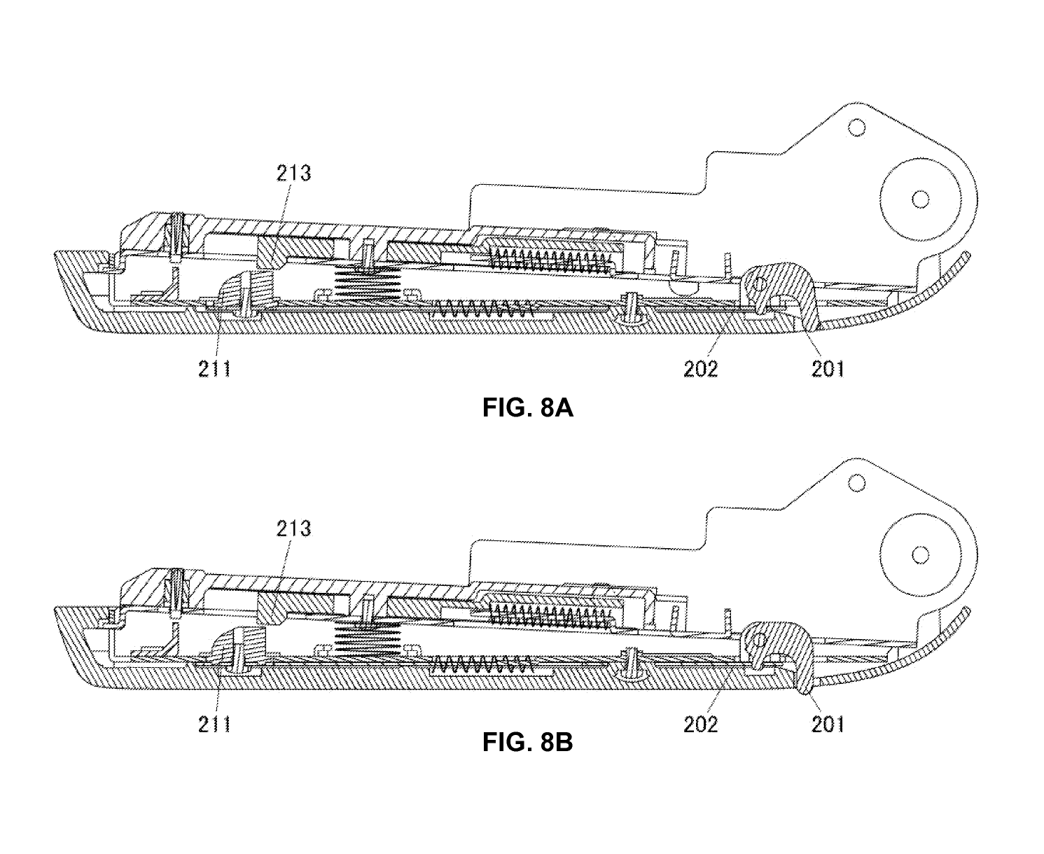

As shown in FIG. 8A and B, the plate 202 is a thin metallic or hard resin flat plate and is positioned between the base bottom plate 171 and the base cover 177. The plate 202 is integrated with the slider receiver 185 at the front thereof and is in engagement with the other end of the U-shaped desk resting lever 201, which is positioned at the front side of the desk resting lever 201, at the rear thereof. The plate 202 is biased to the front by an elastic member 203. Because of this, as has been described above, when the stapler 100 is placed on a table or desk for use as a tabletop or desktop stapler, the plate 202 is caused to slide to the rear by the rotating operation of the desk resting lever 201.

The slider receiver 185 is a solid body (cube) made of hard resin and is integrated with the plate 202 so as to be erected on the plate 202 at the front of the plate 202. Similar to the hand-held operation described above, the second arms 225 of the rotational arms 221 are brought into abutment with the engagement projections 215 which are disposed above the slider receiver 185 as a result of the operation of the rotational arms 221 of the housing portion 120 according to the rotating operation of the handle portion 110, whereby the engagement projections 215 are made integral with the slider plate 211 which is moved to the rear, and as the front end of the handle portion 110 is lowered, the engagement projections 215 move to the rear together with the slider plate 211.

Then, when the slider projection 213 which is integrated with the slider plate 211, which can slidably moves, slides to move to the rear, the locking of the slider receiver 185 which is moved slightly to the rear by the desk resting lever 201 with the slider projection 213 positioned above the slider receiver 185 is released, whereby the clincher portion 190 is allowed to perform a descending operation.

When the base portion 170 of the stapler 100 is placed on the desk or table in this way, as shown in FIG. 8B, the one end of the U-shaped desk resting lever 201 is inclined to the rear, which triggers a synchronous rearward rotation of the other end of the desk resting lever 201, whereby the plate 202 which is in engagement with the other end of the desk resting lever 201 is caused to slide to the rear and this moves slightly the slider receiver 185 which is in engagement with the plate 202 to the rear. Therefore, the release of the engagement between the slider receiver 185 and the slider projection 213 is delayed.

Because of this, even when with the stapler 100 placed on the desk or table, the handle portion 110 is lowered quickly by applying a strong force to the handle portion by the palm of a hand of the user to fasten several tens of sheets of paper together, the time during which the slider projection 213 which operates in association with the rotating operation of the handle portion 110 and the slider receiver 185 is locking each other is slightly extended, whereby the movement of the clincher portion 190 towards the base portion 170 is delayed, thereby making it possible to start a clinching operation after the legs of the staple 251 have been caused to penetrate through the sheets of paper in an ensured fashion.

In addition, when the stapler 100 is held in the hand to fasten several tens of sheets of paper together, the user holds the stapler 100 in such a way that the handle portion 110 and the base portion 170 are closed together by the thumb and the fingers, and therefore, the handle portion 110 is lowered at a speed which is slightly slower than the speed at which the handle portion 110 is pressed strongly downwards by the palm of the hand, whereby the lowering speed of the clincher portion 190 is also slowed slightly, and a staple 251 is forced into the sheets of paper also when the clincher portion 190 is lowered. Thus, when a clinching operation is started, the legs of the staple 251 have penetrated through the sheets of paper in an ensured fashion. Because of this, as shown in FIG. 8A, the movement of the clincher portion 190 towards the base portion 170 does not have to be delayed, and the stapler 100 is constructed so as to be easily held in the hand, whereby the clinching operation is executed after the staple 251 is caused to penetrate through the sheets of paper in an ensured fashion.

In addition, when attempting to fasten a small number of sheets of paper together, even though the lowering speed of the handle portion 10 varies slightly, the legs of the staple 251 can easily penetrate through the sheets of paper. Thus, the clinching operation can be executed after the legs of the staple 251 have penetrated through the sheets of paper in an ensured fashion, and therefore, a required number of sheets of paper can be fastened together properly whether the stapler 100 is used as the desktop or tabletop stapler or the hand-held stapler.

In this way, in the stapler 100 according to the embodiment, even though the handle portion 110 is rotated so as to be lowered quickly and strongly to fasten a large number of sheets of paper with the stapler 100 placed on the desk or table, by delaying the movement of the clincher portion 190 towards the base portion 170, the clinching operation is executed after a staple is allowed to penetrate through the sheets of paper completely. Thus, whether the stapler 100 is used as the desktop or tabletop stapler or the hand-held stapler, irrespective of the number of sheets of paper to be fastened together, it is possible to prevent the buckling of a staple, the floating of a crown of a staple in which the crown is left apart from the top of the sheets of paper, and the outward bending of legs of a staple.

In addition, in the stapler 100 described in the embodiment, the handle portion 110 and the housing portion 120 are connected by the link bar 105 in such a way that the handle portion 110 is disposed above the housing portion 120, whereby the housing portion 120 is lowered by lowering the front end of the handle portion 110. However, the stapler 100 may be configured so that the handle cover 111 is attached directly to the housing top plate 123 of the housing portion 120, the handle portion 120 is rotated towards the base portion 170 directly by the hand, and the clincher portion 190, the magazine portion 140 and the housing portion 120 are disposed above the base portion 170, the housing portion 120 doubling as the handle portion.

According to the embodiment configured as described heretofore, it is possible to provide the stapler 100 which can fasten even a large number of sheets of paper together in a staple fashion whether it is used as the desktop or tabletop stapler or the hand-held stapler.

According to the embodiment, by causing the one end of the desk resting lever 201 to project from the lower surface of the base portion 170, when the stapler 100 is placed on the desk or table, or when the stapler 100 is placed on the desk or table with the handle portion 110 pressed downwards by the hand, the one end of the desk resting lever 201 is allowed to retreat to the lower surface of the base portion 170.

Further, according to the embodiment, when the one end of the desk resting lever 201 is allowed to retreat to the lower surface of the base portion 170, the slider receiver 185 is allowed to retreat, whereby the amount by which the slider receiver 185 and the slider projection 213 are superposed is increased, thereby making it possible to easily delay the start of lowering of the clincher portion 190.

Furthermore, according to the embodiment, the clincher portion 190 moves towards the base portion 170 in association with the rotation of the handle portion 110, whereby whether the number of sheets of paper to be fastened together is large or small, the sheets of paper can be fastened together in an ensured fashion.

While the several embodiments of the invention have been described heretofore, these embodiments are proposed as the examples, and hence, there is no intention to limit the scope of the invention by those embodiments. These novel embodiments can be carried out in other various forms, and it is possible to make various omissions, replacements or alterations thereto without departing from the spirit and scope of the invention. These resulting embodiments and their modifications are included in the spirit and scope of the invention and the scope of inventions which will be claimed later and their equivalents.

What is claimed is:

1. A stapler having, above a base portion, a clincher portion on which sheets of paper to be fastened together with a staple are placed and a housing portion including a magazine portion which accommodates the staple and a driving blade which drives out the staple, comprising:
a desk resting lever which is actuated when the base portion is placed on a desk or the like;
a plate which slides when the desk resting lever is actuated; and
a slider receiver that locks the movement of the clincher portion on which the sheets of paper to be fastened together with the staple are placed towards the base portion and which moves in association with sliding of the plate,
the desk resting lever, the plate and the slider receiver being disposed within the base portion,
wherein when the base portion is placed on the desk or the like, the desk resting lever is actuated to thereby cause the plate to slide to thereby cause the slider receiver which is in engagement with the plate to move slightly, so that the movement towards the base portion of the clincher portion which operates in association with rotating operation of the handle portion is delayed.

2. The stapler according to claim 1, wherein the desk resting lever is disposed so that an end thereof projects from a lower surface of the base portion.

3. The stapler according to claim 1, wherein when the end of the desk resting lever is situated substantially in the same plane as the lower surface of the base portion, the slider receiver retreats slightly.

4. The stapler according to claim 2, wherein when the end of the desk resting lever is situated substantially in the same plane as the lower surface of the base portion, the slider receiver retreats slightly.

5. The stapler according to claim 1, further comprising:
an engagement projection which is brought into abutment with a rotational arm in the housing portion which is actuated by rotation of the handle portion.

6. The stapler according to claim 2, further comprising:
an engagement projection which is brought into abutment with a rotational arm in the housing portion which is actuated by rotation of the handle portion.

7. The stapler according to claim 3, further comprising:
an engagement projection which is brought into abutment with a rotational arm in the housing portion which is actuated by rotation of the handle portion.

8. The stapler according to claim 4, further comprising:
an engagement projection which is brought into abutment with a rotational arm in the housing portion which is actuated by rotation of the handle portion.
